(19) United States
(12) Patent Application Publication
(10) Pub. No.: US 2008/0310560 A1
(43) Pub. Date: Dec. 18, 2008

(54) Apparatus for Estimating Phase Offset of Multiple Survival Paths and Digital Wired/Wireless Communication System Using the Same

(75) Inventors: Pan-Soo Kim, Daejon (KR); Yun-Jeong Song, Daejon (KR); Byoung-Hak Kim, Daejon (KR); Deock-Gil Oh, Daejon (KR); Ho-Jin Lee, Daejon (KR); Jun Heo, Seoul (KR); Joong-Gon Ryoo, Seoul (KR)

Correspondence Address: CANTOR COLBURN, LLP, 20 Church Street, 22nd Floor, Hartford, CT, 06103, US

(73) Assignee: Electronics and Telecommunications Research Institute, Daejon (KR)

(21) Appl. No.: 12/094,717

(22) PCT Filed: May 26, 2006
(86) PCT No.: PCT/KR2006/001974

§ 371 Date: May 22, 2008

(30) Foreign Application Priority Data
Nov. 25, 2005 (KR) 10-2005-0113717
Dec. 15, 2005 (KR) 10-2005-0123817

(51) Int. Cl. H04L 27/06

(52) U.S. Cl. 375/341

(57) ABSTRACT

Provided is an apparatus for estimating phase offsets of multiple survival paths and a satellite communication system using the same. The apparatus includes: upper/lower decoding units for obtaining a phase offset estimation value and estimating phase offsets of each survival path based on a stored parameter estimation value of a previous state inputted from an external device; an interleaving/de-interleaving unit for minimizing correlation between data used to estimate a parameter according to the estimated phase offset value from the upper/lower decoding means; and a phase offset outputting unit for outputting the phase offset value estimated through the upper decoding unit and the de-interleaving unit.

### TECHNICAL FIELD

The present invention relates to an apparatus for estimating phase offsets of multiple survival paths, and a digital wired/wireless communication system using the same; and more particularly, to an apparatus for estimating and compensating a phase offset along survival paths as many as the number of states in turbo decoding by configuring a turbo decoder with a plurality of phase estimators as many as the number of states configuring a trellis in order to estimate a phase offset in a baseband for recovering a receiving signal, and a digital wired/wireless communication system using the same.

### BACKGROUND ART

Wired/wireless communication systems recover an original signal after demodulating a received signal through a radio frequency (RF) module and an intermediate frequency (IF) module. Due to inaccuracy of an analog local oscillator in the RF/IF modules, a demodulator receives a signal with a carrier frequency error when down-converting the received signal to a baseband. In addition, a Doppler frequency error occurs in the demodulator of a receiver under mobile environment. In general, Doppler frequency error makes it difficult for the demodulator to recover the original signal. Therefore, the original signal is restored after removing frequency errors in a baseband through a frequency recovery circuit.

If a phase offset exists after compensating the frequency errors, the residual phase offset consists of a predetermined phase pattern and an added phase noise. If a receiver is configured to employ an error correction code that provides an improved performance in a low signal-to-noise ratio such as a turbo code, the performance of the receiver is seriously degraded even by a little amount of phase offset. In order to overcome the problem, a conventional phase offset estimation using a maximum likelihood (ML) has been introduced in an article by Vincenzo Lottici and Marco Luise, entitled “Embedding carrier phase recovery into interactive decoding of turbo-coded liner modulations, IEEE trans., On Communications, vol. 52, no. 4, April, 2004.

In the conventional phase offset estimation, the phase offset model is assumed to be constant in one data block. That is, the conventional phase offset estimation scheme uses a comparatively simple phase offset model. Also, the probability of transmission symbols obtained from a turbo decoder is obtained by calculating a mean value of all symbols in the conventional phase offset estimation.

The conventional phase offset estimation has a low complexity. However, the conventional phase offset estimation can rarely estimate a phase offset when a lot of phase offset occurs. The performance of the conventional phase offset estimation is even more seriously degraded if an un-predictable irregular phase noise is greatly generated. As another conventional phase offset estimation, a per-survival processing (PSP) was introduced. In the PSP, a turbo decoder is configured of multiple phase estimators corresponding to states of a trellis. Since the PSP mode uses multiple phase estimators, the PSP has an advantage of robust performance even when the phase offset is great. However, the PSP has a complicated structure compared to other estimating scheme using a single estimator. Therefore, the PSP has many difficulties when turbo decoding and phase offset estimation are performed in real time.

A turbo coding scheme generates a channel symbol by combining a part of codeword generated from an upper encoder and a part of a codeword generated from a lower encoder based on a puncturing process. Then, the created channel symbol is transmitted to a receiver. When the receiver receives the channel symbol created by the turbo coding scheme, the receiver must divide the received channel symbol, and the divided channel encoding symbols are inputted to an upper decoder and to a lower decoder, respectively.

If the receiver employs the conventional PSP to estimate phase offsets in the received channel symbols, the phase offsets are estimated using only a part of received channel parameter. Therefore, it is difficult to accurately estimate the phase offset, and the performance of the phase offset estimation may be degraded. the conventional PSP algorithm was introduced by R. Raheli, A. Polydoros, and C. Tzou, entitled “Per-survival processing: A general approach to MLSE in uncertain environments, IEEE Trans. Commun., vol. 43, pp. 354-364, February/March/April 1995. However, it fails to teach the PSP related to characteristics of a decoder for decoding a punctured turbo code. As another conventional PSP based phase offset estimation in a turbo decoder, adaptive iterative detection was disclosed in an article by Achilieas Anastasopoulos and Keith M. Chugg, entitled “Adaptive iterative detection for turbo codes with carrier phase uncertainty,” in GLOBECOM 1999-IEEE Global Telecommunication Conference, no. 1, December 1999, pp. 2369-2374. In the adaptive iterative detection, Gaussian increment is only considered as a phase model. The adaptive iterative detection estimates phases of even number trellis without estimating phases of odd number trellis using a conventional PSP scheme although various phase estimation methods were disclosed. Since the adaptive iterative detection performs the phase estimation in both of a forward metric calculation and a backward recursion, the complexity thereof is very high. Furthermore, the phase estimation is performed under assumption that an initial value of a phase is perfectly estimated at both ends of the trellis. Moreover, the adaptive iterative detection has no prior knowledge relation between phase estimation values in an upper decoder and a lower decoder.

As descried above, the TDMA based satellite communication system requires the phase offset of a carrier to be compensated in order to restore a receiving signal. Especially, very small phase offset may seriously degrade the performance of a system using an error correction code such as turbo code which is operated in a low signal-to-noise ratio.

Therefore, there is a great demand for a phase estimation scheme robust against noise. As the phase estimation scheme robust against noise, a conventional phase estimation method using an external phase estimator was widely used. The external phase estimator uses probability information of transmission symbols generated in iterative decoding of a turbo decoder. However, such a conventional phase estimation method cannot be used as a compensator if the phase error is great or if dispersion of phase noise is large.

In order to overcome the shortcoming, a phase estimation method using multiple phase estimators in a turbo decoder was introduced. That is, the multiple phase estimators in the turbo decoder are used to estimate the phase instead of using the external phase estimation in order to improve the accuracy of phase estimation. Since the multiple phase estimators are used, the complexity thereof is very high compared to the conventional phase estimation method using a single external estimator. Therefore, it is difficult to simultaneously perform the phase estimation and the turbo-code decoding in real time.

Therefore, there is great demand for a method of estimating a phase offset for reducing a complexity and improving performance by adaptively changing phase error estimation schemes according to the puncturing pattern of a turbo code in order to restore a receiving signal in a TDMA based satellite communication system.

### DISCLOSURE

### Technical Problem

It is, therefore, an object of the present invention to provide an apparatus for estimating and compensating phase offsets along survival-paths as many as the number of states in a turbo decoding by configuring a turbo decoder with a plurality of phase estimators as many as the number of states in a trellis and a TDMA based satellite communication system using the same.

### Technical Solution

In accordance with one aspect of the present invention, there is provided an apparatus for estimating phase offsets of multiple survival paths including: an upper/lower decoding unit for obtaining a phase offset estimation value and estimating phase offsets of each survival path based on a stored parameter estimation value of a previous state inputted from an external device; an interleaving/de-interleaving unit for minimizing correlation between data used to estimate a parameter according to the estimated phase offset value from the upper/lower decoding means; and a phase offset outputting unit for outputting the phase offset value estimated through the upper decoding unit and the de-interleaving unit.

In accordance with another aspect of the present invention, there is provided a time division multiple access (TDMA) based satellite communication system for restoring a receiving signal including: a plurality of apparatus for estimating phase offsets of multiple survival paths selectively as many as the number states configuring a trellis, wherein the apparatus estimates phase offsets along survival paths as many as the number of states in turbo decoding.

### ADVANTAGEOUS EFFECTS

In the present invention, a plurality of phase estimators in a turbo decoder is used corresponding to multiple survival paths to compensate a phase offset and to recover a signal in a TDMA based satellite communication system. Therefore, superior performance may be guaranteed even in an inferior phase offset environment.

In the present invention, phase offset estimation is performed for 4 times of trellis. Therefore, the complexity of the phase offset estimation is reduced to 4 times compared to a conventional PSP. Since the phase offset is not unreasonably estimated based on an incomplete receiving value in the present invention, the performance of the phase offset estimation is improved according to the present invention.

### DESCRIPTION OF DRAWINGS

The above and other objects and features of the present invention will become apparent from the following description of the preferred embodiments given in conjunction with the accompanying drawings, in which:

FIG. 1 is a block diagram illustrating a TDMA-based satellite communication system using a PSP-based turbo decoder in accordance with the present invention;

FIG. 2 is a block diagram showing a multiple survival path phase offset estimating apparatus in the PSP-based turbo decoder in accordance with an embodiment of the present invention;

FIG. 3 is a block diagram depicting a multiple survival path phase offset estimating apparatus in accordance with another embodiment of the present invention;

FIG. 4 is a view describing how to apply three types of phase estimation in accordance with an embodiment of the present invention; and

FIG. 5 is a graph showing the performance of phase offset estimation using probability information shown in FIG. 4.

### BEST MODE FOR THE INVENTION

Other objects and aspects of the invention will become apparent from the following description of the embodiments with reference to the accompanying drawings, which is set forth hereinafter.

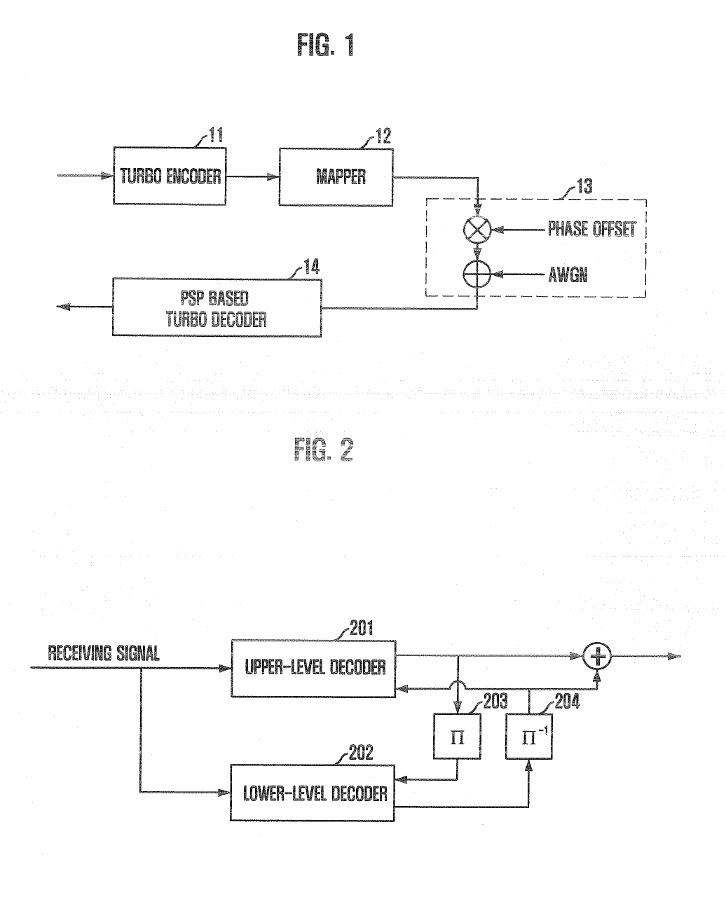

FIG. 1 is a block diagram illustrating a Time Division Multiple Access (TDMA)-based satellite communication system using a PSP-based turbo decoder in accordance with the present invention. The turbo decoder 14 employs per survival processing (PSP) and the turbo decoder 14 includes an apparatus for estimating phase offset of multiple survival paths. That is, the TDMA-based satellite communication system includes a turbo encoder 11, a mapper 12, a phase offset and AWGN (channel model) removing block 13 and the turbo decoder 14.

As shown in FIG. 1, the TDMA-based satellite communication system using an apparatus for estimating a multiple path phase offset according to the present embodiment includes the turbo encoder 11 for generating a bit string combined of real data and parity data by encoding data based on a recursive systematic convolutional (RSC) code, a mapper 12 for mapping the bit string generated from the turbo encoder 11 to a symbol, a phase offset and AWGN removing block 13 for removing carrier phase offset and Gaussian variance noise, and a turbo decoder 14 for estimating phase offsets along survival paths as many as the number of states and compensating the estimated phase offsets in the turbo decoding.

FIG. 2 is a block diagram showing a multiple survival path phase offset estimating apparatus in the PSP-based turbo decoder in accordance with an embodiment of the present invention;

Differently from conventional turbo decoders, the turbo decoder 14 directly receives a signal from a channel without passing through a demapper, which is a corresponding unit of the mapper 12.

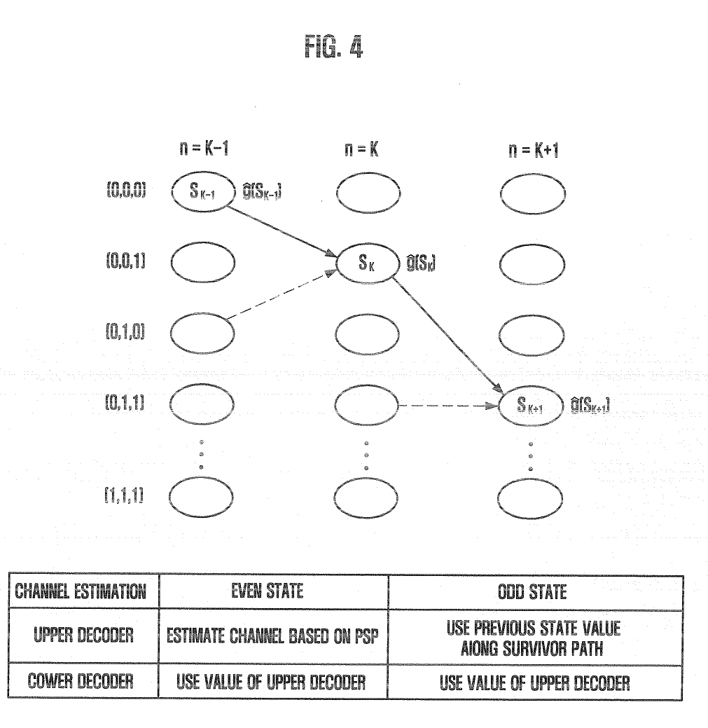

As shown in FIG. 2, the PSP-based turbo decoder 14 employing multiple survival paths includes an upper turbo decoder 201 (Adaptive SISO (soft input soft output)_Upper) and a lower turbo decoder 202 (Adaptive SISO (soft input soft output)_Lower). The upper turbo decoder 201 includes a plurality of parameter estimators corresponding to states of trellis. The upper turbo decoder 201 obtains newly compensated parameter values for survival paths based on a parameter estimation value stored at a previous state. The estimating operation will be described in detail with reference to FIG. 4 later. The upper decoder 201 includes a plurality of parameter estimators corresponding to states of trellis and calculates a newly compensated parameter value for survival path based on the parameter estimation value stored at a previous state.

The turbo decoder 14 further includes an interleaver 203 and a de-interleaver 204 for minimizing correlation of data that is used for restoring a signal or estimating parameters. That is, such interleaver 203 and de-interleaver 204 are generally used in a common turbo decode for minimizing influence of errors in adjacent data.

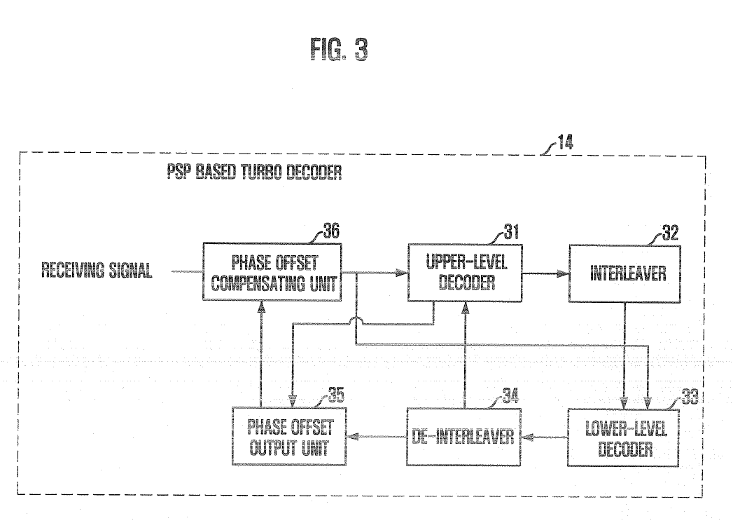

FIG. 3 is a block diagram depicting a multiple survival path phase offset estimating apparatus in accordance with another embodiment of the present invention. The apparatus for estimating phase offsets of multiple survival paths includes an upper decoder 31, a lower decoder 33, an interleaver 32, a de-interleaver 34, a phase offset output unit 35, and phase offset compensating unit 36.

The upper and lower decoders 31 and 33 estimate phase offsets of survival paths based on a Log A Posterior Probability Ratio (LPPR) of a current state. The current state is calculated based on the Equation 1 and the parameter estimation value stored the previous state (see Eq. 2). That is, phase offset value of the current state is calculated based on a receiving signal inputted from a state buffer. The interleaver 32 and the de-interleaver 34 minimize the correlation between data used to estimate a parameter according to the estimated phase offset value at the upper and lower decoders 31 and 33. The phase offset output unit 35 receives the estimated phase offsets from the upper decoder 31 outputting the received phase offsets. The phase offset compensating unit 36 receives the phase offsets from the phase offset output unit 35, and compensates the receiving signal based on the received phase offsets from a second decoding operation and outputs a compensated signal to the upper decoder 31.

Herein, the upper decoder 31 estimates a phase according to a conventional PSP in even trellis and uses a stored value at a previous state along a survival path in odd trellis.

The lower decoder 33 copies the phase offset estimation value estimated and stored in the upper decoder 31 and uses the copied phase offset estimation value corresponding to each state.

In the present embodiment, the phase estimation is performed in a forward direction only. The estimated phase offset value obtained at the forward direction is stored and reduced for a backward direction. That is, the phase offset estimation value estimated and stored at the forward direction is reused for the backward direction without performing the phase estimation. Therefore, complexity thereof is reduced according to the present embodiment. Also, it assumes that a phase is imperfectly estimated at both ends of the trellis.

FIG. 4 is a view for describing three types of phase estimation in accordance with the present invention. That is, the PSP based channel estimation schemes according to the present invention are schematically shown based on trellis in FIG. 4. Referring to FIGS. 2 and 4, a first phase estimation scheme uses per survival processing (PSP) for all states and all decoders 201 and 203. In a second phase estimation scheme, the upper decoder 201 uses a typical PSP at even-number states and uses previous state values at odd-number states to estimate the phase offsets. The lower decoder 203 applies the PSP at the even number states and uses previous even number state values to estimate the phase offsets as like as the upper decoder 201. In a third phase estimation scheme, the lower decoder 203 uses a value that was used by the upper decoder 201 at a previous state according to the present invention.

As shown in FIG. 4, Sₖ denotes each of the state values. The PSP based phase estimation scheme according to the present invention estimates a phase of a current state based on a previous phase in a path selected through an add compare selection (ACS) scheme that is used in the Viterbi algorithm. Such an estimation scheme is a least mean square scheme and it can be expressed as below Eq. 1.

ĝₖ₊₁=gₖ+β(rₖ−gₖα)α* Eq. 1

In Eq. 1, ĝₖ denotes a k^{th} phase \hat{θ}ₖ expressed as an exponential function (e^{e}). That is, if a k^{th} phase value is known, a next phase value can be estimated. rₖ denotes a receiving signal, and β is a step size.

rₖ=cₖ·e^{j(2πΔfT}^{ₖ}^{+θ}^{ₖ}⁾+nₖ Eq. 2

In Eq. 2, Cₖ denotes a modulated symbol, nₖ is AWGN noise, and ΔfTₖ is a carrier frequency error or Doppler error. θₖ is a carrier phase offset.

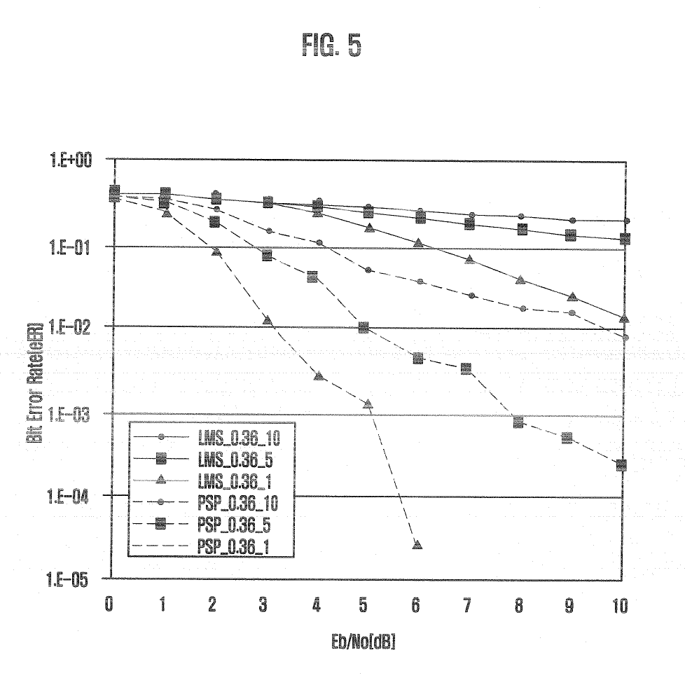

FIG. 5 is a graph showing the performance of phase offset estimation using probability information shown in FIG. 4. That is, performance of a singe estimation, Least Mean Square (LMS) and performance of a plurality of estimations PSP.

In order to demonstrate the superiority of the present invention, simulation is performed under the following conditions. A coding rate is ½ and a modulation scheme is QPSK, and a size of input block is 424 bits which is the same as 1 ATM. The picture shows Bit Error Rate (BER) when a phase noise mode has variance with 1°, 5° and 10° and a phase for a modulated symbol is rotated about 0.2° per each symbol.

That is, a curve LMS_{—}0.2_{—}10 represents a result of a phase estimation using a LMS method with channel environment that a phase offset rotation is 0.2° per a symbol, and variance is 10° in a phase noise model.

As described above, in order to estimate a phase offset in a baseband, a phase offset is repeatedly compensated by changing the internal structure of a turbo decoder to a multiple survival paths phase offset estimation. In this case, the multiple phase estimations are divided into three phase estimation schemes and the three phase estimation schemes are selectively applied according to a punching pattern of a turbo encoder in the turbo decoder. That is, the three phase estimation schemes are a regular PSP scheme, a reproduction on survival path scheme and a reproduction scheme. In the regular PSP scheme, a conventional PSP is used. In the reproduction on survival path scheme, a stored phase estimation value of a previous state is used although survival paths are determined. In the reproduction scheme, a phase estimation value estimated at an upper decoder is used in a lower decoder.

The above described method according to the present invention can be embodied as a program and stored on a computer readable recording medium. The computer readable recording medium is any data storage device that can store data which can be thereafter read by the computer system. The computer readable recording medium includes a read-only memory (ROM), a random-access memory (RAM), a CD-ROM, a floppy disk, a hard disk and an optical magnetic disk.

The present application contains subject matter related to Korean patent application Nos. 2005-0113717 and 2005-0123817, filed in the Korean Intellectual Property Office on Nov. 25, 2005, and Dec. 15, 2005, the entire contents of which is incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for estimating phase offsets of multiple survival paths comprising:
upper/lower decoding means for obtaining a phase offset estimation value and estimating phase offsets of each survival path based on a stored parameter estimation value of a previous state inputted from an external device;
interleaving/de-interleaving means for minimizing correlation between data used to estimate a parameter according to the estimated phase offset value from the upper/lower decoding means; and
phase offset outputting means for outputting the phase offset value estimated through the upper decoding means and the de-interleaving means.

2. The apparatus as recited in claim 1, wherein the upper decoding means estimates a phase based on a per survival process (PSP) in even trellis and uses a value stored at a previous state along a survival path in odd trellis.

3. The apparatus as recited in claim 1, wherein the phase estimation is performed and an estimation value is stored in a forward metric calculation, and the stored estimation value is reused in a backward recursion.

4. The apparatus as recited in claim 1, wherein the lower decoding means copies and uses a phase offset estimation value, which is estimated and stored at the upper decoding means, according to each state location.

5. The apparatus as recited in claim 1, wherein the parameter estimated value stored at the previous state is a receiving signal expressed as:
rₖ=cₖ·e^{j(2πΔfT}^{ₖ}^{+θ}^{ₖ}⁾+nₖ
where Cₖ denotes a modulated symbol, nₖ is AWGN noise, ΔfTₖ is a carrier wave frequency error or Doppler error and θₖ is a carrier wave phase offset.

6. The apparatus as recited in claim 1, wherein the phase offset estimation value is obtained by estimating a phase of a current state based on a previous phase through an equation:
ĝₖ₊₁=gₖ+β(rₖ−gₖα)α*
where ĝₖ denotes a k^{th} phase \hat{θ}ₖ expressed as an exponential function (e^{e}), a (k+1)^{th} phase is estimated based on a k^{th} phase, rₖ denotes a receiving signal, and β is a step size.

7. The apparatus as recited in claim 6, wherein the phase offset estimation value is obtained based on tentative symbols derived from a Log A Posterior Probability Ratio (LPPR).

8. The apparatus as recited in claim 1, wherein the apparatus for estimating phase offsets of multiple survival paths selectively applies a regular PSP scheme, a copy on survival path scheme and a reproduction scheme according to a puncturing pattern of a turbo code, where the regular PSP scheme uses a PSP scheme, the reproduction on survival path scheme uses a phase estimation value stored at a previous state although a survival path is determined, and the reproduction scheme uses the phase offset estimation value, which is estimated at the upper decoding means, in the lower decoding means.

9. The apparatus as recited in claim 1, wherein the upper and lower decoding means share the phase estimation value.

10. A digital wired/wireless communication system for restoring a receiving signal, the system comprising:
a plurality of apparatuses for estimating phase offsets of multiple survival paths selectively as many as the number states configuring a trellis,
wherein the apparatus estimates phase offsets along survival paths as many as the number of states in turbo decoding.

11. The digital wired/wireless communication system as recited in claim 10, wherein the apparatus for estimating phase offsets of multiple survival paths includes:
upper and lower decoding means for obtaining a phase offset estimation value and estimating phase offsets of each survival path based on a stored parameter estimation value of a previous state inputted from outside;
interleaving and de-interleaving means for minimizing correlation between data used to estimate a parameter according to the estimated phase offset value from the upper/lower decoding means; and
a phase offset outputting means for outputting the phase offset value estimated through the upper decoding means and the de-interleaving means.

12. The digital wired/wireless communication system as recited in claim 10, wherein the apparatus for estimating phase offsets of multiple survival paths selectively uses a regular PSP scheme, a copy on survival path scheme and a copy scheme according to a puncturing pattern of a turbo code, where the regular PSP scheme uses a PSP scheme, the copy on survival path scheme uses a phase estimation value stored at a previous state although a survival path is determined, and the copy scheme uses the phase offset estimation value obtained at the upper decoding means, in the lower decoding means.

13. The digital wired/wireless communication system as recited in claim 12, wherein the phase offset estimation value is obtained based on tentative symbol derived from a Log A Posterior Probability Ratio (LPPR).
